(19) United States
(12) Patent Application Publication
(10) Pub. No.: US 2008/0209034 A1
(43) Pub. Date: Aug. 28, 2008

(54) Home Network System, Method of Controlling the Same, Method of Setting Residential Gateway For the Same, and Method of Processing Event Protocol For the Same

(75) Inventors: Young-sik Shin, Seoul (KR); Han-sik Jang, Kyonggi-do (KR); Yong-gil Park, Gyonggi-do (KR)

Correspondence Address: LOWE HAUPTMAN HAM & BERNER, LLP, 1700 DIAGONAL ROAD, SUITE 300, ALEXANDRIA, VA, 22314, US

(73) Assignee: SK TELECOM CO., LTD., Seoul (KR)

(21) Appl. No.: 11/994,352

(22) PCT Filed: Jul. 4, 2005
(86) PCT No.: PCT/KR05/02107

§ 371 Date: Dec. 31, 2007

(51) Int. Cl. G06F 15/173; G06F 21/00; H04L 9/32

(52) U.S. Cl. 709/224; 726/3; 726/7; 709/223

(57) ABSTRACT

The present invention relates to a home network system, in which devices constituting a home network can be installed to be provided with home network service, and can be controlled using various terminals, and to a method of controlling the home network system, method of setting a residential gateway and method of processing an event protocol for the home network system. In the home network system, an HNSN (100) includes a user/device information Database (130) for storing information about a user and electronic appliances, an HnsnRgIF (140) that is a process for performing registration, authentication and connection management for an RG, an HnsnUPnP (120) that is a process for performing device control and event control for the RG, and an application server (110) for analyzing requests and providing a control command to the HnsnUPnP, and transmitting a response to the control command to the user terminal.

### TECHNICAL FIELD

The present invention relates, in general, to a home network system, a method of controlling the home network system, a method of setting a residential gateway for the home network system and a method of processing an event protocol for the home network system and, more particularly, to a home network system, in which devices constituting a home network can be installed so as to be provided with home network service, and can be controlled using various terminals, and to a method of controlling the home network system, a method of setting a residential gateway for the home network system, and a method of processing an event protocol for the home network system.

### BACKGROUND ART

Generally, home networking is implemented to integrate information electronic appliances in the home, including a Personal Computer (PC), into a single network, thus enabling communication. Home networking has been rapidly popularized, with the development of networking technology, base software, and information electronic appliances.

Home networking in a narrow sense is limited to network technology for integrating wired/wireless schemes, but home networking in a wide sense can be a general term of integration with information electronic appliances based on network technology, and base software capable of controlling and managing this hardware.

In home networking, the development of networking technology, the information electronic appliances operated based on the networking technology, and application software for smoothly operating such an integrated environment, must be realized together, so that the completion level and standardization of related technologies are most important.

Recently, for software middleware, Java Intelligent Network Infra-structure (JINI), Home Wide Web (HWW), Home Audio Video Interoperability (HAVi), Universal Plug and Play (UPnP), etc. are presented as standards, and have been competitively developed. Among the software middleware, UPnP is a standard for allowing services, provided by various devices that constitute a network, to be conveniently used. For example, when a printer is connected to the network, the printer can be immediately used without requiring a separate procedure of installing a driver.

A UPnP-capable device supports a protocol defined in UPnP and provides the function of defining and expressing service, supported by the device. The service provided by the UPnP-capable device can be used through a control point within the network or Internet browser.

The control point finds available services connected to a network using a Simple Service Discovery Protocol (SSDP), obtains service definition described in eXtensible Markup Language (XML) from the services, and controls the services. The application fields of a UPnP-capable device are predicted to be offices or homes. Application technology for the UPnP-capable device has attracted attention in that typical home users have insufficient professional knowledge about computers or communication networks.

The UPnP technology includes a protocol set based on Transmission Control Protocol/Internet Protocol (TCP/IP):
‘Simple Service Discovery Protocol 1.0’ (<http://search.ie.org/internet-drafts/draft-cai-ssdp-v1-01.txt>)
‘multicast discovery of Domain Name Server (DNS) service’ (<draft-manning-multicast-dns-01.txt>)
‘extensible markup language’-XML (1.0 W3C recommendation)
support of all interfaces (ISA, PCI, VESA, USB, etc.) and all networks, and applicability to all network protocols.

Meanwhile, there is a plurality of prior patent applications related to home network service. Among the prior patent applications, two main prior patents related to a home network system are described. First, a home network system (filed by Samsung Electronics: Korean Pat. Appln. No. 10-2001-0071338) includes a gateway that is connected to a plurality of electronic appliances, and a set-top box that transmits/receives information to/from a control subject, used by a user, has product information about the electronic appliances and is connected to the gateway. Accordingly, this patent is advantageous in that, since the set-top box has display information and control information about the electronic appliances, a program and a user authentication procedure, required for the user to control the electronic appliances, are not necessary, and there is no need to provide a separate authentication module, and in that, since the set-top box transmits information appropriate to the resolution of a TV, a server does not need to provide a separate screen control device for TVs.

However, the above patent is problematic in that a set-top box for TVs is required to construct a home network, and it is difficult for a user having no set-top box to construct a home network.

Meanwhile, a home network system (filed by LG telecom: Korean Pat. Appln. No. 10-2002-0010934) relates to a home network system capable of efficiently controlling a network to correspond to a home network environment. The home network system provides a remote control server for controlling the remote transmission/reception of data in a home network through a Web or WAP server connected to an external PC over the Internet, a typical PC installed in a home, and a Graphical User Interface (GUI) implemented in the browser of the PC, and performs a control operation in response to a user control command through a user interface, a user control command through a browser thereof and a user command through the remote control server.

The above patent is implemented so that a home PC is placed in the center of a home network system to control electronic appliances. Such a system is problematic in that, since the system uses the home PC, the system must be individually constructed in each home, and in that the entire home network is nonfunctional when the PC is upgraded or the PC operating system is newly installed.

In addition to the two representative prior patents, other prior patents also disclose only the construction of a home network, in which a gateway is connected to electronic appliances, in the description of the home network, but do not disclose stages ranging from the gateway to a remote terminal and an external server for controlling the home network.

Further, there is a plurality of patents including a method of controlling a home network using a remote user terminal. However, the patents disclose the invention based on the control of a plurality of electronic appliances connected to the home network at the time of controlling the home network, but do not disclose a scheme enabling the connection to various user terminals or a communication method between a user terminal and a server through the connection.

Meanwhile, a control device capable of integrally managing devices (electronic appliances) distributed in the home to correspond to various communication protocols has been developed. That is, a control device for home networks, capable of supporting all communication protocols, such as Institute of Electrical & Electronic Engineers (IEEE) 1394, Universal Serial Bus (USB), Infrared Data Association (IrDA), X-10 or Lonwork, has been developed.

However, the above patent is problematic in that the standardization of an interworking protocol between a Home Network Serving Node (HNSN), functioning as a central server provided for the above-described home network or home automation, and a Residential Gateway (RG) installed in homes, has not been accomplished yet.

In the meantime, home devices, such as a home theater system, are frequently controlled using a single common control unit called a remote controller. Such a single common control unit allows a house owner to control and command a plurality of different home devices using a single interface. That is, a plurality of producers has developed control units for controlling and commanding various home devices using a single interface.

A problem related to the usage of the remote control unit for commanding and controlling home devices is that the remote control unit provides a static command logic to control and command individual home devices. Therefore, a specific remote control unit can only control and command home devices having the required control and command logic.

For example, if a remote control unit only includes logic for controlling a TV, a Video Cassette Recorder (VCR) and a Digital Versatile Disk (DVD), but does not include logic for controlling a Compact Disk (CD) unit, the remote control unit cannot be used to command or control the CD unit. Moreover, with the development of new home devices, a remote control unit cannot control or command new home devices that require control and command logic that was not known at the time when the remote control unit was developed.

Furthermore, the remote control unit can be merely used to command and control home devices placed within range of the remote control unit. Accordingly, the user cannot use the remote control unit from one region in the home to control and command home devices that are connected to each other but are placed in other regions in the home.

Another problem related to the usage of the remote control unit is that a known remote control unit cannot control a plurality of different types of devices, that is, it cannot control a plurality of devices, having different capabilities and communicating with each other, so as to complete tasks or provide service. Moreover, conventional network systems do not provide a mechanism for software applications in different network devices that automatically communicate with each other to complete tasks without a direct command from a user.

Currently used networks only allow the communication and control of devices connected to a network (for example, 1394) using a central user interface without the capability of providing a user interface or control operation for devices and services connected to different networks (for example, the Internet).

Further, currently used networks do not allow remote communication and control with devices connected to a network (for example, 1394 home network) via different networks (for example, the Internet).

This problem occurs because port forwarding used in a network device uses a private IP. Currently, many services are provided using a private IP. In particular, when a home network system is intended to provide service in the home, there are many cases in which it is difficult to provide service if a port forwarding function is not supported (for example, in the case of a Session Initiation Protocol [SIP] Phone).

Therefore, technology of providing dynamic control and command for respective devices operated in conjunction with the home network is required.

A plurality of prior patents related to a conventional home network device and method exists, but patents related to Short Message Service (SMS) and Location Based Service (LBS) have not been disclosed yet. However, there is a prior art entitled an interworking method between a home network and an instant messenger (Korean Pat.

Appln. No: 10-2002-0034380, filed by Seoul Commtech Co., Inc.). The prior art is adapted to provide an interworking method between a home network and an instant messenger so as to allow the home network and an instant messenger service to interwork and safely and accurately notify a user of the current home situation. In this case, an instant messenger server is connected to a home network server through the Internet, and the user boots a computer in his or her office and accesses the instant messenger server to actually monitor the current home situation through the instant messenger. The prior art is described so that the home network server is connected to a remote inspection unit, an electronic appliance control unit, a doorlock control unit, an emergency warning unit, etc., similar to a conventional home network, all functions are centered around the home network server, and corresponding information is transmitted to the instant messenger server and displayed on the instant messenger of a user computer, so that the current home situation can be safely and accurately transmitted in real time through the instant messenger, thus enabling a home network function to be efficiently utilized.

### DISCLOSURE OF INVENTION

### Technical Problem

The prior art is constructed so that, only when a user accesses an instant messenger and requests information about the current home situation, can the current home situation be recognized. The prior art is an invention different from the present invention, and has problems in that, if trouble occurs in the home when the user is not monitoring the current home situation, the trouble cannot be immediately made known, and in that electronic appliances arranged in the home are only devices having a sensor and a control unit, and SMS transmission/reception service and location information request service cannot be provided using the electronic appliances, except for an advantage in that the current home situation can be monitored in real time.

Further, there are problems in that the standardization of an interworking protocol between an HNSN, functioning as a central server, and an RG, installed in the home, which are provided for the above-described home network or home automation, has not been realized yet.

### Technical Solution

Accordingly, the present invention has been made keeping in mind the above problems occurring in the prior art, and an object of the present invention is to provide a system, in which devices constituting a home network can be installed so as to be provided with home network service, and can be controlled using various terminals, and an RG setting method for protocols related to the setting of the port forwarding table of an RG, operating in conjunction with an HNSN, and registration, authentication and connection management for the RG, and a method of processing events when the events, such as a gas leak or an open door, occur in a home network device.

### ADVANTAGEOUS EFFECTS

According to the present invention, the following advantages can be obtained.

First, devices constituting a home network are placed and can be controlled using various terminals, so that home network service can be provided.

Second, a user can remotely access and set a port table of an RG, operating in conjunction with an HNSN system, at an arbitrary remote place, so that the user can execute dynamic control operations and commands with respect to various devices of the home network system.

Third, efficient home network service can be provided by efficiently performing registration, authentication and connection management for the RG.

Fourth, when events, such as a gas leak or an open door, occur in a home network device, a user can monitor and control the occurrence of the events, or notify a police station or fire station of the occurrence of the events, thus preventing accidents that may become serious.

### BRIEF DESCRIPTION OF THE DRAWINGS

FIG. 1 is a view showing the construction of a home network system according to a first embodiment of the present invention;

FIG. 2 is a first block diagram showing a home network service provision server and a peripheral system according to the present invention;

FIG. 3 is a first flowchart of a method of controlling a home network system according to the present invention;

FIG. 4 is a view showing the construction of a home network system according to a second embodiment of the present invention;

FIG. 5 is a second flowchart showing a method of controlling a home network system according to the present invention;

FIG. 6 is a third flowchart showing a method of controlling a home network system according to the present invention;

FIG. 7 is a view showing the construction of a home network system according to a third embodiment of the present invention;

FIG. 8 is a second block diagram showing a home network service provision server and a peripheral system according to the present invention;

FIG. 9 is a view showing an RG I/F protocol stack of the home network system according to the present invention;

FIG. 10 is a view showing a UPnP protocol stack of the home network system according to the present invention;

FIG. 11 is a fourth flowchart showing a method of controlling a home network system according to the present invention;

FIG. 12 is a fifth flowchart showing a method of controlling a home network system according to the present invention;

FIG. 13 is a view showing the construction of a home network system according to a fourth embodiment of the present invention;

FIG. 14 is a sixth flowchart showing a method of controlling a home network system according to the present invention;

FIG. 15 is a seventh flowchart showing a method of controlling a home network system according to the present invention; and

FIG. 16 is an eighth flowchart showing a method of controlling a home network system according to the present invention.

### BEST MODE FOR CARRYING OUT THE INVENTION

The present invention provides a home network system comprising a residential gateway which is a gateway connected to electronic appliances constituting a home network, a user terminal, a network, and a Home Network Serving Node (HNSN) which is a server for connecting the network to the RG and controlling the home network, wherein the HNSN comprises a user/device information Database (DB) for storing information about a user and the electronic appliances connected to the RG; an HnsnRgIF that is a process for performing registration, authentication and connection management for the RG; an HnsnUPnP that is a process for performing device control and event control for the RG; and an application server for analyzing a request received from the user terminal and providing a control command to the HnsnUPnP, and transmitting a response to the control command, received from the HnsnUPnP, to the user terminal.

Further, the present invention provides a method of controlling a home network system, the home network system comprising a Home Network Serving Node (HNSN) which is a server for controlling electronic appliances constituting a home network, a user terminal including a Web, WAP, PDA or SKVM terminal, and a Web server for connecting the user terminal to the HNSN, comprising the steps of receiving an ID and password through the user terminal and authenticating a user through the Web server; the Web server requesting a list of devices connected to the home network, managed by the user, from the HNSN if authentication of the user has succeeded; the HNSN, having received the request, transmitting the requested list of devices to the Web server; the Web server converting the received list of devices and transmitting the converted list of devices to the user terminal, and the user terminal displaying the received list of devices; the user terminal requesting control of a specific device; transmitting a requested control signal to the HNSN through the Web server; the HNSN executing a process suitable for the control signal; the HNSN transmitting a response to the process to the Web server; and the Web server converting the received response and transmitting the converted response to the user terminal.

Further, the present invention provides a method of controlling a home network system using protocol between a server (Home Network Serving Node: HNSN), which controls residential devices through a central server, and the residential devices, comprising the steps of transmitting a device control message to the HNSN if the user selects a device control command through a user application server; the HNSN transmitting the device control message to a Residential Gateway (RG), and transmitting a device control message response received from the RG to the user application server; transmitting a status monitoring message to the HNSN if the user selects a status monitoring command through the user application server; and the HNSN transmitting the status monitoring message to the RG and transmitting a status monitoring message response from the RG to the user application server.

Further, the present invention provides a method of setting a Residential Gateway (RG) in a home network system, which includes a Home Network Serving Node (HNSN) for providing home network service, a plurality of devices used in a home, and the RG functioning as a gateway, the method setting the RG based on the Internet for wireless Internet connection between the HNSN and the RG, comprising the steps of selecting a command for setting a port table of the RG through a user application; transmitting an action request message (ACTION-Req) to the HNSN in response to the port table setting command; transmitting the action request message from the HNSN to the RG; the RG executing the port table setting command depending on each action; and transmitting an action response message (ACTION-Res) from the RG to the HNSN.

Further, the present invention provides a method of setting a residential gateway using a home network system, which includes a central server (HNSN) connected to a mobile network and adapted to control devices and transmit control status thereof, and a Residential Gateway (RG) connected to the central server (HNSN) through a network and connected to a plurality of devices, comprising the steps of the gateway transmitting a registration request message, including an ID, password and IP, to the central server; storing the registration request message received through an interface of the central server in a database; the central server transmitting a registration response message, including IP and port thereof, to the gateway; the gateway transmitting an authentication request message, including an ID, password and IP, to the central server at preset intervals if registration has been completed; and storing the authentication request message, received through an interface of the central server, in a database, and updating the database.

Further, the present invention provides a method of processing an event protocol for home network devices in a home network system, which includes a central server (HNSN) connected to a mobile network and adapted to control devices and transmit control status thereof, and a Residential Gateway (RG) connected to the HNSN through a network and connected to a plurality of devices, comprising a first step of the central server receiving an event reception request message transmitted by a user; a second step of transmitting the received event reception request message to the gateway, and the gateway transmitting the event reception request message to a corresponding device; a third step of transmitting an event reception response message from the device to the gateway, and the gateway transmitting the event reception response message to the central server; a fourth step of transmitting an event occurrence message generated by the device to the central server through the gateway; and a fifth step of the central server transmitting an event occurrence response message to the corresponding device via the gateway.

Further, the present invention provides a method of processing an event protocol in a home network system, which includes a Home Network Serving Node (HNSN), a Residential Gateway (RG), one or more home network devices, a Short Message Service (SMS) center, a Mobile Switching Center (MSC), and a mobile terminal, comprising the steps of inputting a terminal number of a person, to which an SMS message is to be transmitted, and content through one of the home network devices; transmitting the input number and content to the HNSN through the RG; the HNSN transmitting the input number and content to the SMS center; and the SMS center transmitting an SMS message to a destination mobile terminal via the MSC placed at a location, at which the destination mobile terminal exists, after authenticating the user.

Further, the present invention provides a method of processing an event protocol in a home network system, which includes a Home Network Serving Node (HNSN), a Residential Gateway (RG), one or more home network devices, a Short Message Service (SMS) center, a Mobile Switching Center (MSC), and a mobile terminal, comprising the steps of requesting transmission of a prestored phone number and content through an SMS message if a preset event occurs in one of the home network devices; transmitting the phone number and content to the HNSN via the RG; the HNSN transmitting the received phone number and content to the SMS center; and the SMS center transmitting an SMS message to a destination mobile terminal via the MSC placed at a location, at which the destination mobile terminal exists, after authenticating the user.

Further, the present invention provides a method of processing an event protocol in a home network system, which includes a Home Network Serving Node (HNSN), a Residential Gateway (RG), one or more home network devices and a Location Based Service (LBS) server, comprising the steps of inputting a phone number of a person, location information of whom is desired to be known, through one of the home network devices; transmitting the input phone number to the HNSN via the RG; the HNSN determining whether the input phone number is a number available for location inquiry, providing inquiry denial notification to the home network device through the RG and displaying the inquiry denial notification on a Web screen of the device if it is determined that location inquiry is not possible, while requesting location information from the LBS server if it is determined that location inquiry is possible; the LBS server detecting location information about a corresponding terminal and transmitting detected location information to the HNSN; and the HNSN displaying the location information on a Web screen of a corresponding device via the RG.

### MODE FOR THE INVENTION

Hereinafter, the construction and operation of embodiments of the present invention will be described in detail with reference to the attached drawings.

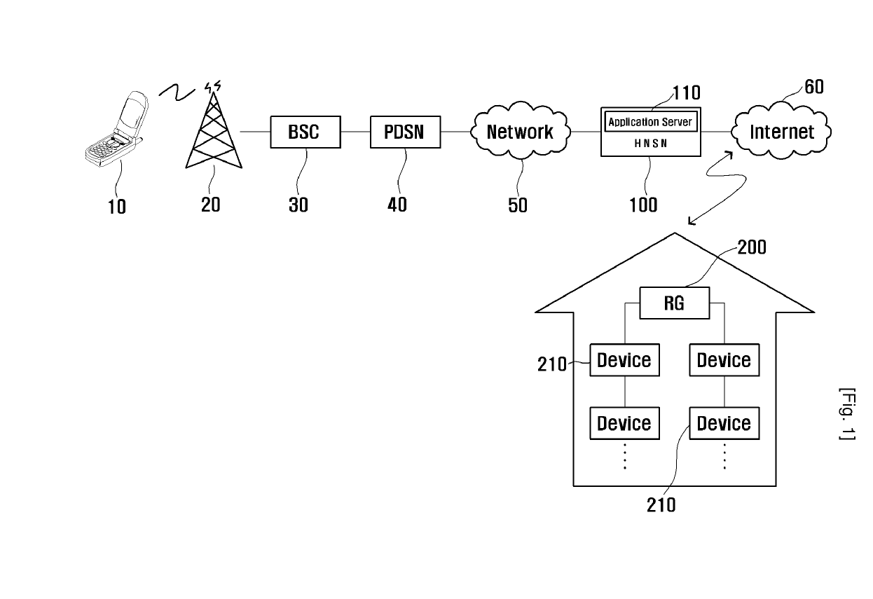

FIG. 1 is a view showing the construction of a home network system according to a first embodiment of the present invention. As shown in FIG. 1, a home network system using a mobile phone is depicted. The present invention includes all schemes, such as a Personal Digital Assistant (PDA), Wireless Application Protocol (WAP) or the Web, as well as a mobile phone. Hereinafter, a system using a mobile phone is described in detail.

First, the system includes a user terminal 10, which is a mobile communication terminal; a Base Transceiver Station (BTS) 20 for enabling wireless communication with the user terminal and transmitting/receiving signals to/from a Base Station Controller (BSC) 30 placed on a transmission path; the BSC 30 for receiving a signal from the BTS and performing a control operation; a Packet Data Serving Node (PDSN) 40 for forwarding a signal from the BSC 30 to a network 50; a Home Network Serving Node (HNSN) 100 for providing home network service in response to a request received from each terminal; and a Residential Gateway (RG) 200 that is a gateway for connecting residential devices and electronic appliances (hereinafter referred to as electronic appliances or home network devices) to each other through the Internet. Electronic appliances 210 connected to the RG 200 may include a door switch system, security system, A/V system for home theater, TV, VCR, Direct Broadcast Satellite Services (DBSS) system known as a Digital Satellite Services (DSS) system, sprinkler system, lighting system, microwave oven, dishwasher, oven/stove, washing machine/dryer, and electronic device, such as a processing system in a car. The system is implemented to include a scheme using a Personal Communication System (PCS) phone, cellular phone, Code Division Multiple Access (CDMA) 2000, International Mobile Telecommunication (IMT)-2000 or Wideband-CDMA (W-CDMA) phone, as well as the mobile phone, and is implemented to be capable of controlling the HNSN 100 even through schemes involving the Web, WAP, a Personal Digital Assistant (PDA), an SK virtual machine (SKVM) or Wireless Internet Platform for Interoperability (WIPI).

The HNSN 100 is described in detail. The HNSN 100 is a server constructed to provide a service of controlling and monitoring all devices in the home between each user terminal 10 and the RG 200.

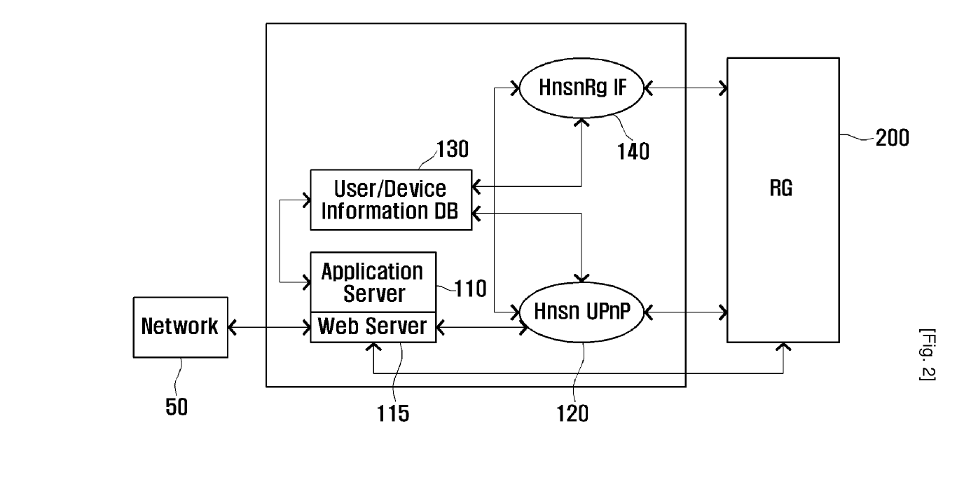

FIG. 2 is a first block diagram showing a home network service provision server and a peripheral system according to the present invention. As shown in FIG. 2, the internal construction of the HNSN 100 is depicted, and respective components are described in detail below.

An application server 110 exists to allow a user terminal 10 to perform transmission or reception to or from the HNSN 100 through a network 50. The application server 110 receives a request from each terminal, processes the request, converts a response from an HnsnUPnP 120 into a format suitable for the terminal, and transmits the converted response. The application server 110 includes a Web server 115 to interface with the terminal, thus enabling signal transmission to the application server.

In the meantime, the HnsnUPnP 120 is a process for receiving device control and event control commands from the application server 110 and processing the commands, or receiving requests from the RG and processing the requests. Further, an HnsnRgIF 140 is a process for performing registration, authentication and connection management for the RG. A user/device Information database (DB) 130 is a DB that operates in conjunction with the HnsnUPnP 120 and HnsnRgIF 140 and stores therein information about the user and electronic appliances connected to the RG.

In this way, the basic functions of respective internal components of the HNSN 100 are described. On the basis of the functions, signal transmission and control performed between respective components to control and register the home network are described.

The application server 110 is a core component of the HNSN 100, and receives requests from the terminal and processes the requests. The application server 110 is constructed to read stored information about the user and electronic appliances, connected to the RG, from the user/device Information DB 130, and to control the RG 200 using the HnsnUPnP 120. First, the user terminal 10 accesses the Web server 115 of the application server 110 through the network 50. The application server 110 analyzes a user request, input from the user terminal 10, using eXtensible Markup Language (XML), and transmits analysis results to the HnsnUPnP 120. Thereafter, the application server 110 receives a response to the request from the HnsnUPnP 120, converts the response into a format suitable for the user terminal 10 using XML, and transmits the converted response to the user terminal 10 through the WEB server 115.

In the above process, signals between the application server 110 and the HnsnUPnP 120 use the following protocols.

First, in order to view a list of devices connected to the RG, HyperText Transfer Protocol (HTTP) based on TCP/IP is used. In order to control devices, Simple Object Access Protocol (SOAP) based on TCP/IP is used. In order to control device events, General Event Notification Architecture (GENA) based on TCP/IP is used.

When a signal is transmitted by the application server 110 to HnsnUPnP 120, the HnsnUPnP 120 and the RG 200 mutually transmit the signal to control an electronic appliance 210 connected to the RG 200. On the contrary, a request from the RG is also processed. Moreover, the HnsnUPnP 120 also functions to load information about the electronic appliance 210 connected to the RG 200, and store the loaded information in the user/device Information DB 130. If the RG 200 and the HnsnUPnP 120 are operated in conjunction with each other in this way, the following protocols are used.

In order to discover an electronic appliance, Simple Service Discovery Protocol (SSDP)/GENA based on User Datagram Protocol (UDP)/IP is used. In order to maintain an information file about the electronic appliance, HTTP, based on TCP/IP is used. In order to control the electronic appliance and monitor the status thereof, SOAP, based on TCP/IP is used. In order to control the events of the electronic appliance, GENA, based on TCP/IP is used.

Meanwhile, the HnsnsRgIF 140 is a process of performing registration, authentication, and connection management for the RG, communicates with the RG 200 using SOAP based on TCP/IP, and is capable of receiving and processing a request from the RG 200. SOAP is described in detail. Register SOAP based on TCP/IP is used to register the RG, and Alive/Bye SOAP based on TCP/IP is used to perform connection management for the RG, thus enabling the HnsnRgIF 140 and the RG 200 to communicate with each other.

The HnsnUPnP 120 and the HnsnRgIF 140 are processes executed by daemons.

Further, each process executes an operation of parsing XML data about request and response messages, and an operation of referring to or changing the user/device Information DB 130.

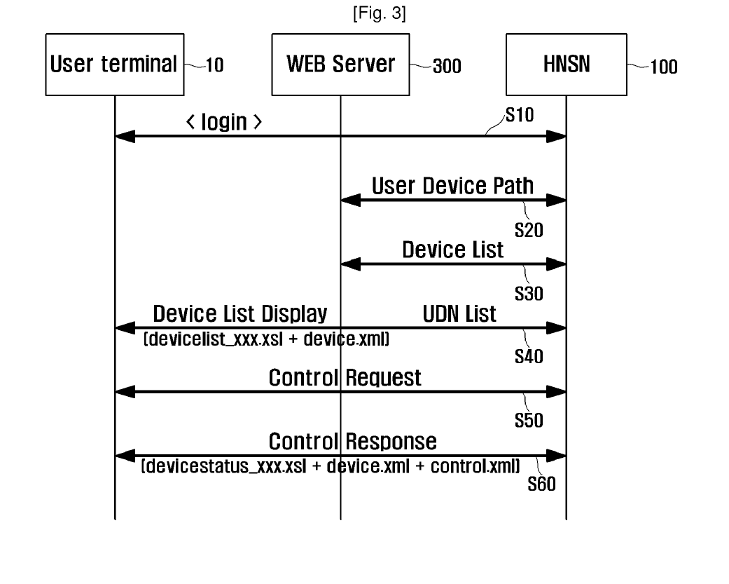

FIG. 3 is a first flowchart showing a method of controlling a home network system according to the present invention. As shown in FIG. 3, the method is shown using the user terminal 10, a Web server 300 and the HNSN 100. In the drawing, parts corresponding to the Internet 60, the RG 200 and the electronic appliances 210 subsequent to the HNSN of FIG. 1 are omitted, and it is inclusively shown that a user accesses the network through the user terminal 10 and the Web server 300 regardless of a terminal and a scheme used by the user.

Entire call processing is executed to analyze a corresponding request and show results of the requested service to the user through the communication with the HNSN 100 when the user requests the home network service using the user terminal. Processing of each call is described in detail below.

First, the user is authenticated by inputting an ID and password using a Web browser, WAP, PDA or SKVM on the user terminal at step S10. If the authentication of the user has succeeded, information about a directory for storing information about the device (electronic appliance) 210 of the home network of the user is transmitted by the HNSN 100 to the Web server 300 at step S20. The Web server 300 requests a list of various devices (electronic appliances) 210, managed by the user, from the HNSN 100 at step S30.

The Web server 300 receives the requested list of devices (XML) from the HNSN 100, converts the device list by combining the device list with eXtensible Stylesheet Language (XSL) for a device list that exists on a specific directory, and displays the converted device list on the screen of the user at step S40. The XSL for a device list is provided by the server, and data are converted and transmitted using devicelist_web.xsl, devicelist_wap.xsl, devicelist_pda.xsl or devicelist_skvm.xsl, depending on the type of user terminal (web/, wap/, pda/ or skvm/), respectively.

If the user performs an input operation to request the status or control of a specific device after the devices of the user's home network are displayed on the user terminal through the above-described method, the Web server 300 transmits the status or control request to the HNSN 100 at step S50. In this case, XSL is used for the status of the device. In addition to XSL basically provided by the server, XSL for a display manufactured by each device manufacturing company can be used.

The HNSN 100, having received the status or control signal for the device, executes a process for a corresponding signal, transmits a response (XML) to the received signal to the Web server 300, converts the response by combining the response with XSL for the device display, and displays the converted response on the screen of the user at step S60. Even in this case, data are converted and transmitted using devicestatus_web.xsl, devicestatus_wap.xsl, devicestatus_pda.xsl or devicestatus_skvm.xsl, depending on the type of user terminal (web/, wap/, pda/ or skvm/), respectively.

A protocol stack between the Web server 300 and the HNSN 100 uses HTTP.

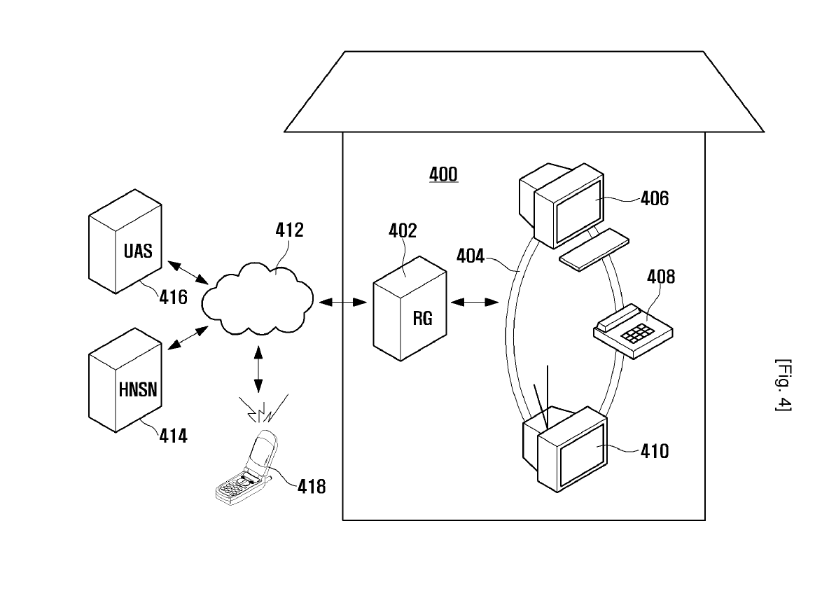

FIG. 4 is a view showing the construction of a home network system according to a second embodiment of the present invention. As shown in FIG. 4, a home network 400 is constructed through an RG 402 and a local network 404.

A gateway is a network point that functions as an entrance for entering another network. From the standpoint of routing, the Internet can be considered as a network composed of a plurality of gateway nodes and host nodes. Computers of network users or computers for providing content, such as Web pages, are host nodes. Computers for controlling traffic in the network of a normal company or the computers of Internet service providers are gateway nodes. Therefore, the RG 402 may be considered as the gateway installed in a typical home.

The local network 404 is implemented through a telephone line, power line, wireless Local Area Network (LAN), etc. In FIG. 1, the local network 404 is connected to different types of home network devices 406, 408 and 410 to provide a function of sharing information, is connected to a television receiver, digital set-top box, audio speaker, etc., to provide a function of exchanging AV information, or is connected to a refrigerator, washing machine, boiler, etc., to provide a function of controlling the devices.

The RG 402 is connected to a Home Network Serving Node (HNSN) 414 through a network or the Internet 412. The HNSN 414 is a system for managing the RG 402 to allow the RG 402 to access the Internet or be provided with a plurality of additional services.

A User Application Server (UAS) 416 can directly provide service to service users 402 and 418 through the network or Internet 412, or can provide service to the service users 402 and 418 via the HNSN 414.

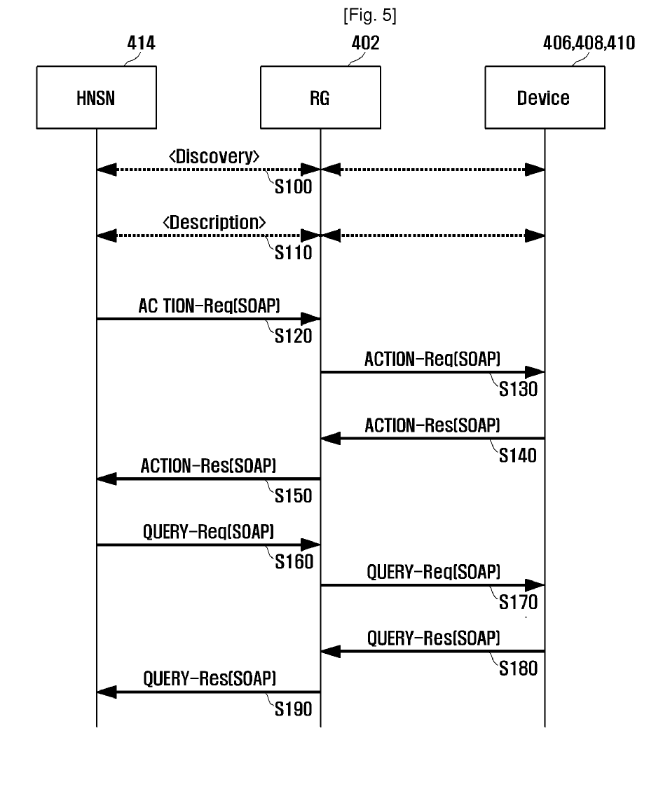

FIG. 5 is a second flowchart showing a method of controlling a home network system according to the present invention. As shown in FIG. 5, the HNSN 414 provides a function of remotely controlling home network devices managed by the RG 402. This function can be simultaneously used by a terminal as well as a Web screen.

First, discovery step S100 and description step S110 perform a procedure defined in the UPnP protocol. That is, at the discovery step S100 performed by the HNSN 414, respective devices 406, 408 and 410 are discovered through the RG 402, and at the description step S110, device description files for the devices 406, 408 and 410 and service description files are received.

Next, if the user selects a device control command through the user application server 416, a SOAP request message for the corresponding command (ACTION-Req) is transmitted to the HNSN 414.

Next, the HNSN 414 transmits the received SOAP request message (ACTION-Req) to the RG 402 at step S160, and transmits a SOAP response message (ACTION-Res) from the RG 402 to the user application server 416 at steps S120 to S150.

Next, if the user selects a status monitoring command through the user application server 416, a SOAP request message for the corresponding command (QUERY-Req) is transmitted to the HNSN 414.

Next, the HNSN 414 transmits the received SOAP request message (QUERY-Req) to the RG 402 at step S160, and transmits a SOAP response message (QUERY-Res) from the RG 402 to the user application server 414 at steps S160 to S190.

A protocol stack for this process uses SOAP (HTTP) based on TCP/IP.

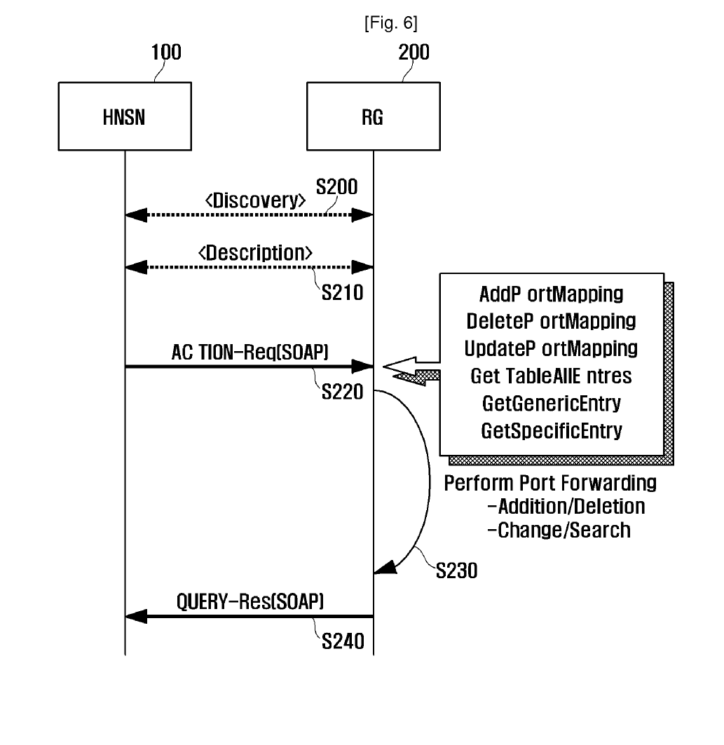

FIG. 6 is a third flowchart showing a method of controlling a home network system according to the present invention. As shown in FIG. 6, if the user selects a command for setting the port table of the RG 200 on the Web screen, the setting of the port table of the RG 200 is performed. This setting is described in detail below.

First, discovery step S200 and description step S210 perform a procedure defined in the UPnP protocol.

That is, at the discovery step S200 performed by the HNSN 100, the RG 200 is recognized as a UPnP Device, and at the description step S200 by the HNSN 100, device description files for the RG 200 and service description files used to set a port table are received.

In this state, if the user selects a command for setting the port table of the RG 200 through the user application, a SOAP request message is transmitted to the HNSN 100.

The HNSN 100 transmits the received SOAP request message (ACTION-Req: AddPortMapping/DeletePortMapping/UpdatePortMapping/GetTableAllEntries/GetGenericEntry/GetSpecificEntry) to the RG 200 at step 220.

Then, the RG 200 executes the port table setting command, such as addition, deletion, change or search, depending on each action at step S230.

Finally, the RG 200 transmits a SOAP response message (ACTION-Res) to the HNSN 100 at step S240.

As described above, a protocol stack used to set the port table according to the present invention uses SOAP (HTTP) based on TCP/IP.

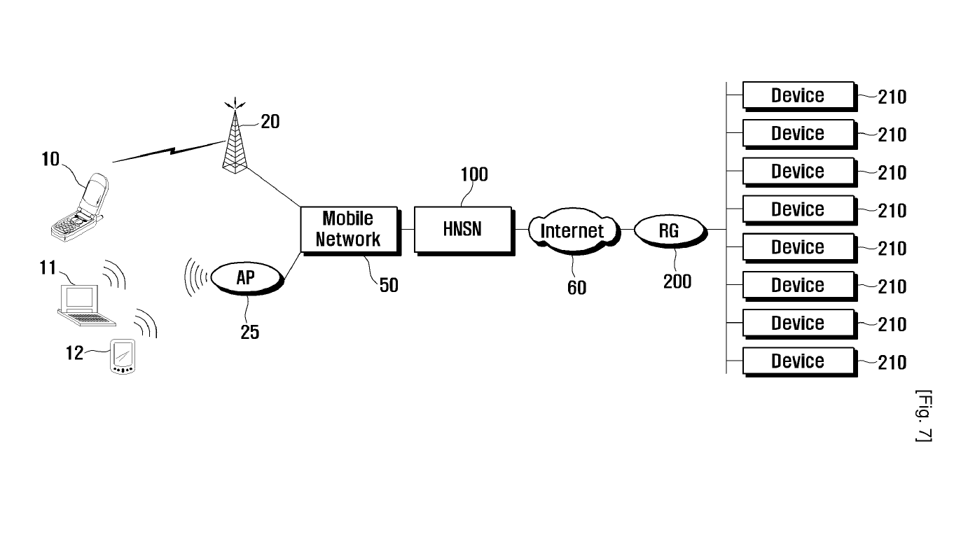

FIG. 7 is a view showing the construction of a home network system according to a third embodiment of the present invention. As shown in FIG. 7, an HNSN system is composed of a region for generating a control/control status signal, a network for transmitting/receiving the control/control status signal, a region for performing registration, authentication and connection management, the Internet, and a region installed in the home. In particular, the present invention relates to a protocol for interworking between the region for performing registration, authentication and connection management, and the region installed in the home.

The region for generating the control/control status signal can be implemented using a mobile phone (CDMA2000 1x Ev-Do or WCDMA) 10 for generating a control/control status signal and transmitting/receiving data. Further, the region can be implemented using a notebook (WLAN) 11 or PDA (WCDMA or WLAN) 12 for generating a control/control status signal and transmitting/receiving data.

The network for transferring data received from the mobile phone 10, the notebook 11 or the PDA 12, or data received from the HNSN 100 includes a base transceiver station 20 for receiving a control signal from the mobile phone 10 and transmitting the control signal to the network, or transmitting a received control status signal to the mobile phone 10, an Access Point (AP) 25 for receiving a control signal from the notebook 11 or PDA 12 and transmitting the control signal to the network, or transmitting a received control status signal to the notebook 11 or PDA 12, and a mobile network 50 for receiving a signal from the base station 20 and the access point 25 in a wired or wireless manner, and transmitting the signal to the region for performing registration, authentication and connection management.

The region for performing registration, authentication and connection management is a Home Network Serving Node (HNSN) 100 functioning as a central server. The HNSN 100 is connected to the Internet 60 and performs registration (Register), authentication (Alive) or connection management (Bye) for the region installed in the home. The construction of the HNSN 100 will be described in detail later.

The region installed in the home includes a Residential Gateway (RG) 200 connected to the Internet 60, and devices that are operated in conjunction with each other through data processing to be capable of performing control, monitoring and interworking operations and that include electronic appliances, computers, security equipment, remote inspection equipment or remote medical examination equipment, constituting a data network. The same reference numeral is used to designate the devices for convenience of description.

In the entire system having the above construction, the present invention relates to interworking protocol between the HNSN 100 and the RG 200. The HNSN 100, playing an important role, is described.

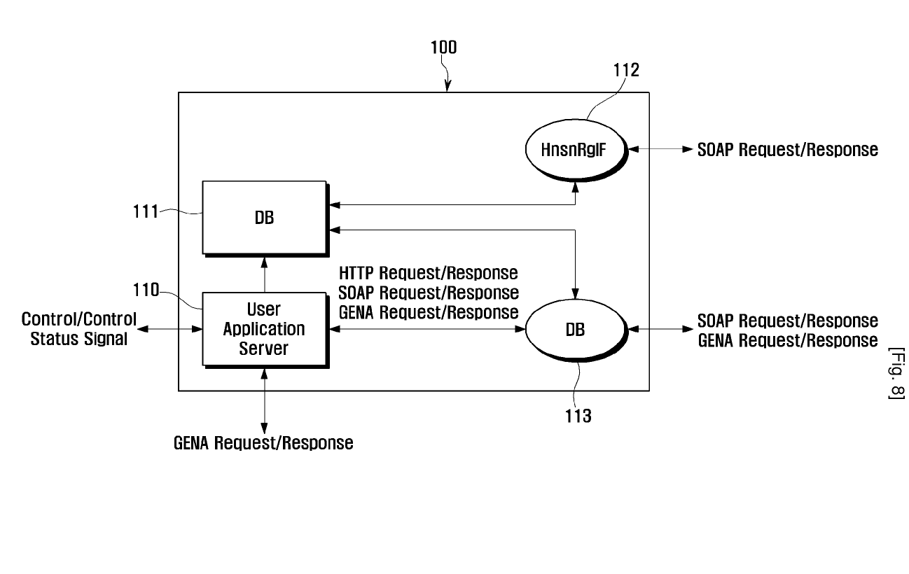

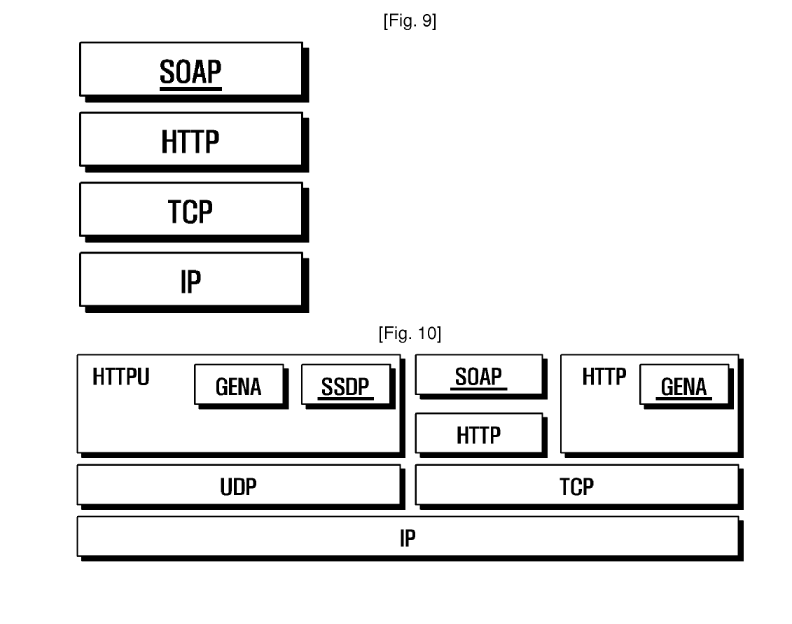

FIG. 8 is a second block diagram showing a home network service provision server and a peripheral system according to the present invention. As shown in FIG. 8, the HNSN 100 includes a user application server 110, a database (DB) 111, an HnsnRgIF 112 and an HnsnUPnP 113.

The user application server 110 receives a control/control status signal from a mobile network, processes the control/control status signal according to a corresponding protocol, transmits the control/control status signal, processed according to the protocol, to the DB 111, and transmits the processed signal to the HnsnUPnP 113 or directly transmits the processed signal to the RG. At this time, messages transmitted to the HnsnUPnP 113 are related to requests and responses about the discovery of devices, the maintenance of description files, the control of devices, the monitoring of the status of devices, and the control of events.

The DB 111 performs the function of updating data corresponding to signals received from the user application server 110, HnsnRgIF 112 and HnsnUPnP 113, storing the updated data and reading stored data.

The HnsnRgIF 112 (HNSN-RG I/F) provides an interface for registration, authentication and connection management using SOAP, and performs a database construction operation of updating the DB 111.

The HnsnUPnP (HNSN UPnP) 113 performs the discovery of devices using SSDP/GENA, maintains description files using HTTP, controls devices and monitors the status thereof using SOAP, and controls device events using GENA.

UPnP is a protocol for exchanging UI and control information between respective digital devices based on Hyper Text Markup Language (HTML) and Extensible Markup Language (XML) that are generally used in the Internet. As shown in FIG. 10, UPnP is composed of Transmission Control Protocol (TCP), Internet Protocol (IP), User Datagram Protocol (UDP), General Event Notification Architecture (GENA), Simple Service Discovery Protocol (SSDP), Simple Object Access Protocol (SOAP), etc.

In this way, the HNSN provides registration, authentication and management functions for the RG. In order for the HNSN to control devices subsequent to the RG, network information about the RG (IP and port) is required. This information is managed by the HNSN through an RG registration procedure. Further, the RG continuously transmits messages after the registration, thus allowing the HNSN to monitor the current status of the RG. Further, all messages between the HNSN and RG contain data required for authentication, so that a message from an HNSN or RG that is not authenticated is denied.

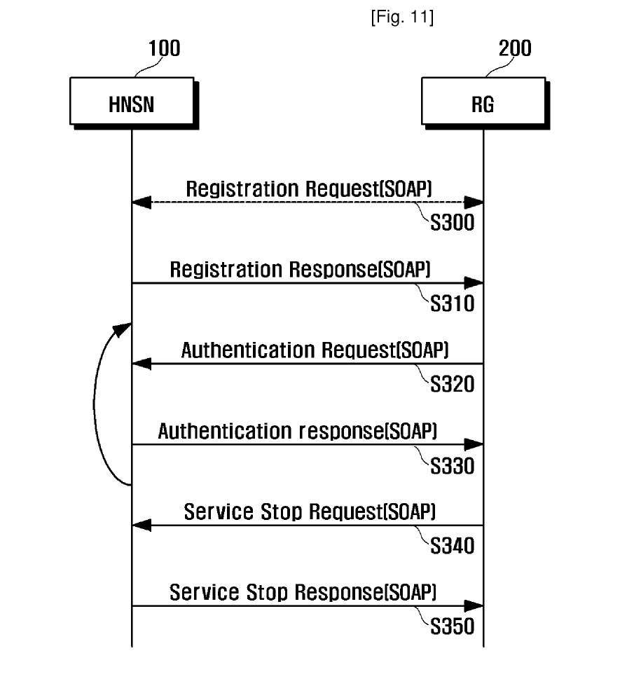

FIG. 11 is a fourth flowchart showing a method of controlling a home network system according to the present invention. As shown in FIG. 11, the RG 200 transmits a message, requesting registration, to the HNSN 100 using information, such as an ID, password or IP, at step S300.

<ID>Tom</ID>

<Password>Tom111</Password>

<IP>123.456.789.1</IP>

This registration requesting message is transmitted to the DB through the HnsnRgIF of the HNSN 100, so that the user information database is changed.

The HNSN 100 transmits a registration response to the RG 200 using network information about the HNSN 100 (IP and port) at step S310.

<ns:RegisterResponse>
<hnsnSSDPUR>234.456.7.8:8001</hnsnSSDPUR>
<hnsnGENAUR>234.456.7.8:8002</hnsnGENAUR>
<Result>1</Result>
</ns:RegisterResponse>

If registration has been successfully completed, the RG 200 transmits an authentication (Alive) message using information, such as an ID, password and IP, at preset intervals, for example, at intervals of 1 minute, thus notifying the HNSN 100 of the status of the RG 200.

<ID>Tom</ID>
<Password>Tom111</Password>
<IP>123.456.789.1</IP>

Therefore, the HNSN 100 stores corresponding information in the user information DB and updates the DB.

Meanwhile, if an authentication message is not transmitted at intervals of 1 minute, the HNSN 100 determines that a failure has occurred in the RG at steps S320 and S330.

If the RG 200 is deleted, that is, if it is determined that service is not provided any more, a service stop (Bye) message is transmitted, and the HNSN 100 changes information about a corresponding user at steps S340 and S350.

A protocol stack for this operation uses SOAP (HTTP) based on TCP/IP.

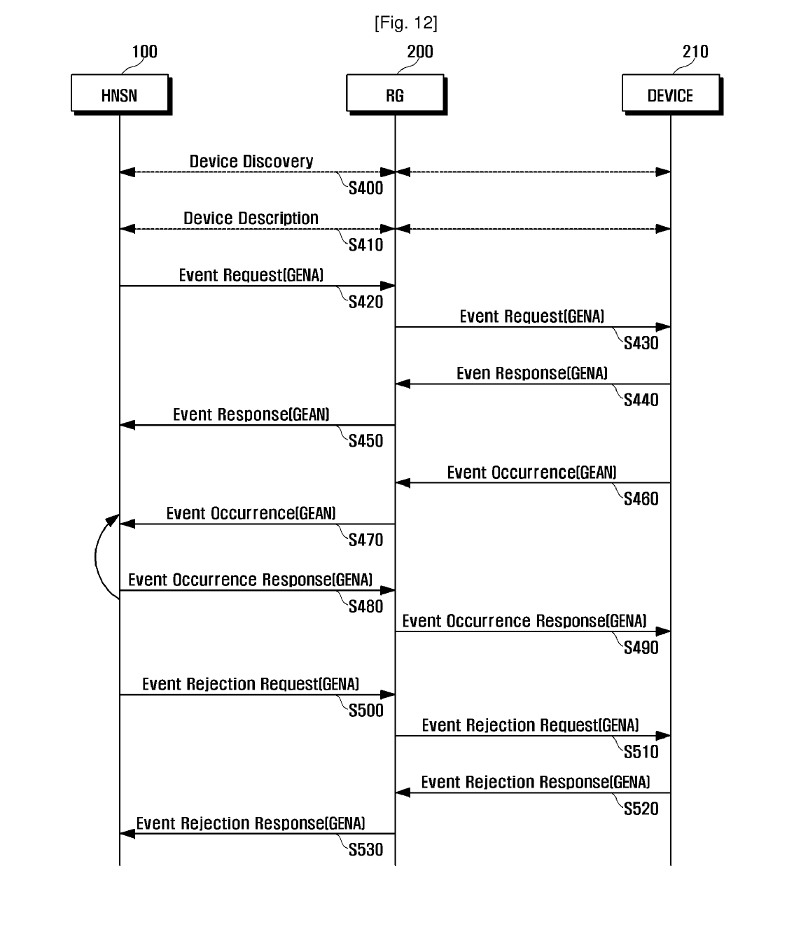

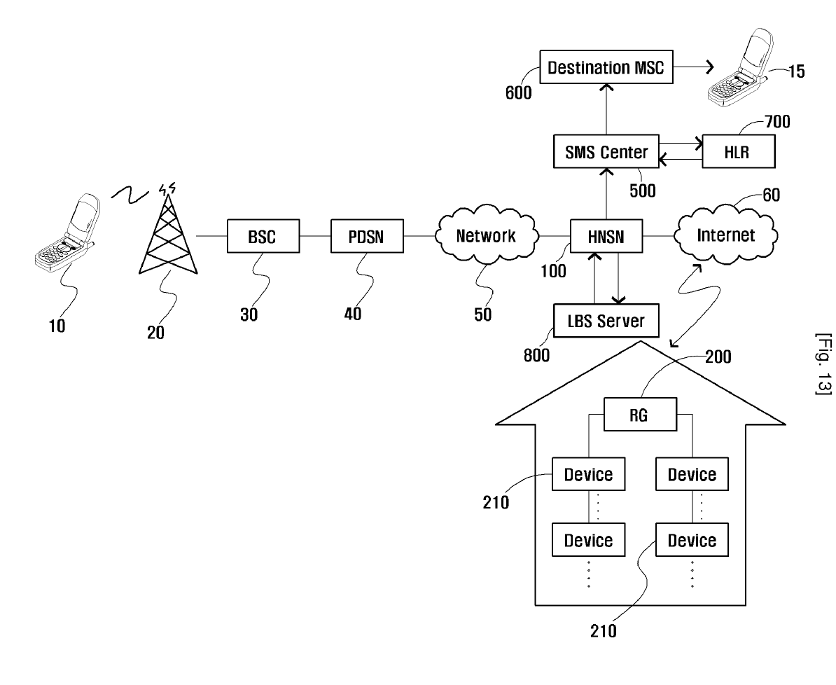

FIG. 12 is a fifth flowchart showing a method of controlling a home network system according to the present invention. Referring to FIG. 12 together with FIGS. 7 and 8, discovery and description are performed through a procedure defined in UPnP. That is, at the discovery step by the HNSN 100, each device is discovered by the RG 200 at step 400, and at the description step, a device description file for each device and a service description file are received at step S410.

As described above, if the user selects an event reception command through the user application after the discovery and description steps have been completed, a corresponding GENA request message is transmitted to the HNSN 100.

The HNSN 100 transmits the received GENA request message to the RG 200 at step S420, and the RG 200 transmits the GENA request message to a corresponding device 210 at step S430. A GENA response message from the corresponding device 210 is transmitted to the RG 200 at step S440, and the GENA response message from the RG 200 is transmitted to the user application server 110 at step S450.

Thereafter, an event occurring in the device 210 is transmitted to the HNSN 100 through the RG 200 in the form of a GENA request message at steps S460 and S470. The transmitted event is stored in the DB 111, and is also directly reported to the user terminals 10, 11 and 12. The HNSN 100 transmits a GENA response message for the event to the device 210 through the RG 200 at steps S480 and S490.

Meanwhile, if the user selects an event rejection command through the user application, a corresponding GENA request message is transmitted to the HNSN 100.

Therefore, the HNSN 100 transmits the received GENA request message both to the RG 200 and the device 210 at steps S500 and 510, and transmits a GENA response message received from the corresponding device 210 and the RG 200 to the user application server 110 at steps S520 and S530. Therefore, an event occurring in the device 210 is not transmitted to the HNSN 100.

A protocol stack for this operation uses GENA (HTTP) based on TCP/IP.

FIG. 13 is a view showing the construction of a home network system according to a fourth embodiment of the present invention. As shown in FIG. 13, the home network system includes a user terminal 10 that includes a PCS phone, cellular phone, CDMA 2000, IMT-2000 or W-CDMA and is a mobile communication terminal, such as Web, WAP, PDA, SKVM or WIPI; a Base Transceiver Station (BTS) 20 for enabling wireless communication with the user terminal and transmitting/receiving signals to/from a Base Station Controller (BSC) 30 placed on a transmission path; the BSC 30 for receiving signals from the BTS and controlling the BTS; a Packet Data Serving Node (PSDN) 40 for forwarding signals from the BSC 30 to a network 50; a Home Network Serving Node (HNSN) 100 for providing home network service in response to a request from each terminal; and a Residential Gateway (RG) 200 that is a gateway for connecting residential devices and electronic appliances (hereinafter referred to as electronic appliances or home network devices) to each other through the Internet. The home network system further includes a Short Message Service (SMS) center 500, operating in conjunction with the HNSN 100 to provide SMS, and a Location Based Service (LBS) server 800 for providing LBS service. Further, in order to provide SMS, a Home Location Register (HLR) 700, a destination Mobile Switching Center (MSC) 600 and a destination terminal 15 are also included in the system. In the meantime, electronic appliances 210 connected to the RG 200 may include a door switch system, security system, A/V system for home theater, TV, VCR, Direct Broadcast Satellite Services (DBSS) system known as a Digital Satellite Services (DSS) system, sprinkler system, lighting system, microwave oven, dishwasher, oven/stove, washing machine/dryer, and electronic device, such as a processing system in a car. In the above construction, the HNSN 100 is described in detail. The HNSN 100 is a server constructed to provide a service of controlling and monitoring each residential device between each user terminal 10 and the RG 200. Meanwhile, the LBS server 800, operating in conjunction with the HNSN 100, is also included in the home network system to provide LBS service.

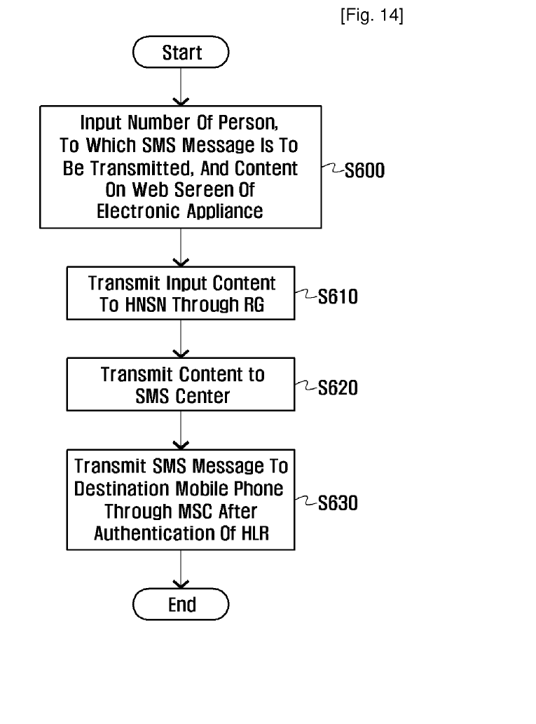

FIG. 14 is a sixth flowchart showing a method of controlling a home network system according to the present invention. Referring to FIG. 14 together with FIG. 13, a user inputs the phone number of a destination user, to which an SMS message is to be transmitted, and message content on the Web screen of the electronic appliance 210 at step S600. In order to perform the step, the electronic appliance 210 is required to additionally include therein a means for displaying a Web screen and inputting information. Such an electronic appliance is also designated as an information electronic appliance, which can operate in conjunction with the Internet.

Meanwhile, the input content is transmitted to the HNSN 100 through the Internet via the RG 200 at step S610. The HNSN transmits the input phone number and content to the SMS center 500 in charge of SMS, thus enabling an SMS message to be provided to a recipient at step S620.

A typical path for transmitting an SMS message to a recipient is described below.

A phone number and message content, transmitted to the SMS center, are processed so that, if a procedure of authenticating a subscriber is performed in the HLR 700 with respect to the corresponding phone number, and authentication has been completed, an SMS message is transmitted to the terminal 15 through the destination MSC 600, connected to the terminal 15 having the corresponding phone number, at step S630.

In the above process, the SMS protocol is transmitted using TCP/IP.

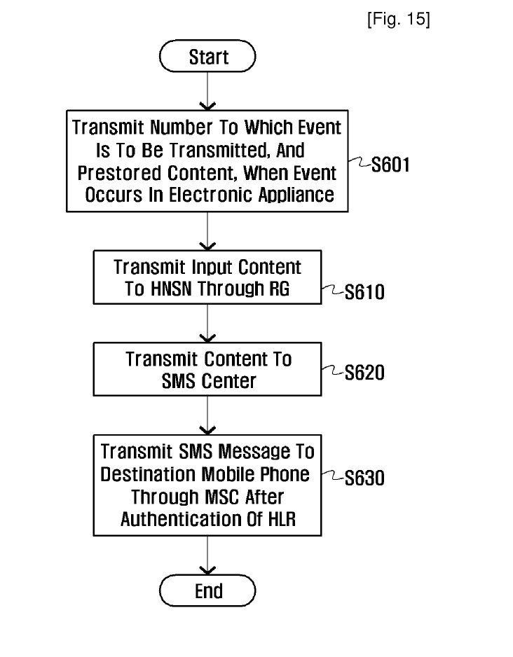

FIG. 15 is a seventh flowchart showing a method of controlling a home network system according to the present invention. Referring to FIG. 15 together with FIG. 13, in the case of a method of transmitting the occurrence of an event to a prestored terminal 15 when the event occurs in an electronic appliance, the transmission of content related to the occurrence of an event to a prestored phone number using an SMS message is requested when an event occurs in an electronic appliance 210 at step S601, unlike the method described in FIG. 14. In this case, it is also possible for the RG 200 to sense the event occurring in the electronic appliance and to request the transmission of an SMS message. Further, it is also possible for the electronic appliance 210 itself to recognize an SMS message and request the SMS message.

The SMS message, requested in this way, is transmitted to the destination terminal 15 through the same process as that of FIG. 14 at steps S610 to S630. The SMS protocol is transmitted using TCP/IP.

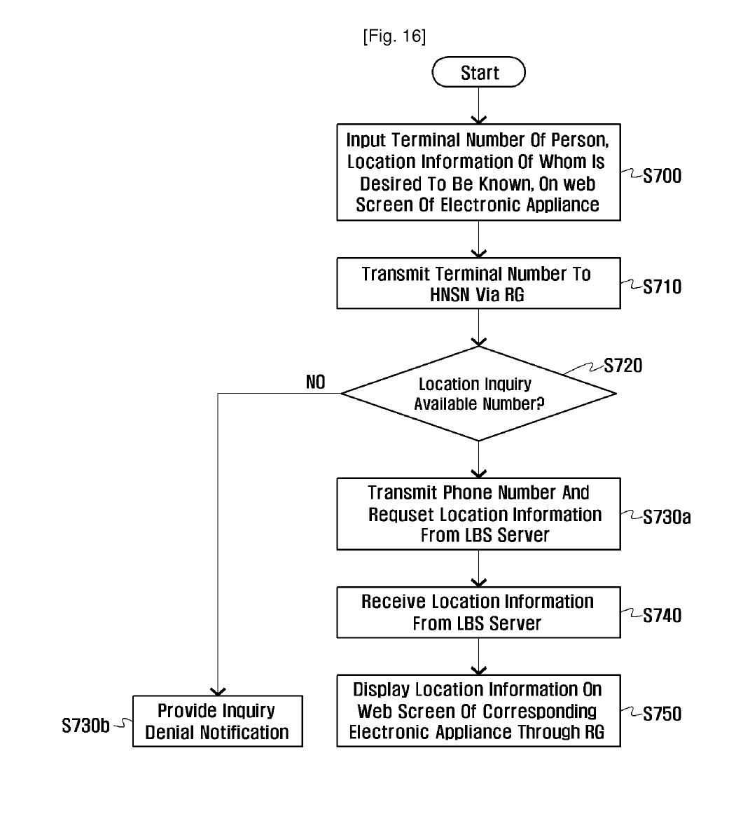

FIG. 16 is an eighth flowchart of a method of controlling a home network system according to the present invention. Referring to FIG. 16 together with FIG. 13, a method of providing LBS service is described below.

First, the phone number of the terminal of a person, the location information of whom is desired to be known, is input on the Web screen of an electronic appliance 210 at step S700. The terminal phone number, input in this way, is transmitted to the HNSN 100 through the RG 200 at step S710. The HNSN 100 determines whether the terminal phone number is the number of an available terminal to which LBS service can be provided at step S720. That is, location information inquiry service is provided only to terminals related to a family, and is not provided to other terminals to avoid invasion of a person's privacy. If the service cannot be provided to the input phone number, the denial of location information inquiry is displayed on the Web screen of the electronic appliance 210 through the RG 200 at step S730b. As described above, it is possible to determine whether LBS service is possible through the DB of the HNSN 100 for storing subscriber information, such as HLR 700, in addition to the embodiment in which the HNSN 100 determines whether LBS service is possible.

If the HNSN 100 determines that location information inquiry is possible, the HNSN 100 transmits the input phone number to the LBS server 800, and requests location information from the LBS server 800 at step S730a. The LBS server 800 detects the location of the terminal having the corresponding phone number, and transmits the detected location information to the HNSN 100 at step S740. The HNSN 100 transmits the location information about the terminal to the RG 200, the RG 200 transmits the location information to the electronic appliance 210, and the electronic appliance 210 displays the location information on the Web screen at step S750.

In the above process, the LBS protocol is transmitted using TCP/IP.

Through the above description, those skilled in the art will appreciate that various modifications, additions and substitutions are possible, without departing from the scope and spirit of the invention as disclosed in the accompanying claims. Therefore, the technical scope of the present invention is not limited to the description of the embodiments, but it should be defined by the accompanying claims.

### INDUSTRIAL APPLICABILITY

As described above, a home network system, a method of controlling the home network system, a method of setting a residential gateway for the home network system and a method of processing an event protocol for the home network system according to the present invention can be usefully utilized for constructing a home network.

1. A home network system comprising a residential gateway which is a gateway connected to electronic appliances constituting a home network, a user terminal, a network, and a Home Network Serving Node (HNSN) which is a server for connecting the network to the RG and controlling the home network, wherein:
the HNSN comprises,
a user/device information Database (DB) for storing information about a user and the electronic appliances connected to the RG;
an HnsnRgIF that is a process for performing registration, authentication and connection management for the RG;
an HnsnUPnP that is a process for performing device control and event control for the RG; and
an application server for analyzing a request received from the user terminal and providing a control command to the HnsnUPnP, and transmitting a response to the control command, received from the HnsnUPnP, to the user terminal.

2. The home network system according to claim 1, wherein the application server comprises a Web server enabling a connection both to the terminal and to the RG.

3. The home network system according to claim 1, wherein the application server, the HnsnRgIF and the HnsnUPnP perform requests and responses therebetween using extensible Markup Language (XML).

4. The home network system according to claim 1, wherein the HnsnRgIF and the HnsnUPnP are processes executed in form of daemons.

5. The home network system according to claim 1, wherein control commands transmitted/received between the application server and the HnsnUPnP include a device list view command, a device control command, and a device event control command.

6. The home network system according to claim 5, wherein the device list view command uses HyperText Transfer Protocol (HTTP), based on Transmission Control Protocol/Internet Protocol (TCP/IP).

7. The home network system according to claim 5, wherein the device control command uses Simple Object Access Protocol (SOAP), based on TCP/IP.

8. The home network system according to claim 5, wherein the device event control command uses General Event Notification Architecture (GENA) protocol, based on TCP/IP.

9. The home network system according to claim 1, wherein the HnsnUPnP and the RG transmit or receive a discovery signal, information file maintenance signal, control signal, status monitoring signal and event control signal for electronic appliances, therebetween.

10. The home network system according to claim 9, wherein the discovery signal for electronic appliances uses Simple Service Discovery Protocol (SSDP)/GENA protocol, based on user Datagram Protocol (UDP)/IP.

11. The home network system according to claim 9, wherein the information file maintenance signal for electronic appliances uses HTTP, based on TCP/IP.

12. The home network system according to claim 9, wherein the control signal for electronics appliances uses SOAP, based on TCP/IP.

13. The home network system according to claim 9, wherein the status monitoring signal for electronic appliances uses SOAP, based on TCP/IP.

14. The home network system according to claim 9, wherein the event control signal for electronic appliances uses GENA protocol, based on TCP/IP.

15. The home network system according to claim 1, wherein the HnsnRgIF and the RG transmit or receive an RG registration signal and an RG connection management signal therebetween.

16. The home network system according to claim 15, wherein the RG registration signal uses Register SOAP, based on TCP/IP.

17. The home network system according to claim 15, wherein the RG connection management signal uses Alive/Bye SOAP, based on TCP/IP.

18. A method of controlling a home network system, the home network system comprising a Home Network Serving Node (HNSN) which is a server for controlling electronic appliances constituting a home network, a user terminal including a Web, WAP, PDA or SKVM terminal, and a Web server for connecting the user terminal to the HNSN, comprising the steps of:
receiving an ID and password through the user terminal and authenticating a user through the Web server;
the Web server requesting a list of devices connected to the home network, managed by the user, from the HNSN if authentication of the user has succeeded;
the HNSN, having received the request, transmitting the requested list of devices to the Web server;
the Web server converting the received list of devices and transmitting the converted list of devices to the user terminal, and the user terminal displaying the received list of devices;
the user terminal requesting control of a specific device;
transmitting a request control signal to the HNSN through the Web server;
the HNSN executing a process suitable for the control signal;
the HNSN transmitting a response to the process to the Web server; and
the Web server converting the received response and transmitting the converted response to the user terminal.

19. The home network system control method according to claim 18, wherein the list of devices is implemented in extensible Markup Language (XML).

20. The home network system control method according to claim 18, wherein the Web server converts the received list of devices by combining the received list of devices with extensible Stylesheet Language (XSL) for a device list.

21. The home network system control method according to claim 18, wherein the response is implemented in XML.

22. The home network system control method according to claim 18, wherein the Web server converts the received response by combining the response with extensible Stylesheet Language (XSL) for a device display.

23. A method of controlling a home network system using protocol between a server (Home Network Serving Node: HNSN), which controls residential devices through a central server, and the residential devices, comprising the steps of:
transmitting a device control message to the HNSN if the user selects a device control command through a user application server;
the HNSN transmitting the device control message to a Residential Gateway (RG), and transmitting a device control message response received from the RG to the user application server;
transmitting a status monitoring message to the HNSN if the user selects a status monitoring command through the user application server; and
the HNSN transmitting the status monitoring message to the RG and transmitting a status monitoring message response from the RG to the user application server.

24. The home network system control method according to claim 23, further comprising the step of the HNSN discovering the RG as a UPnP device during a discovery procedure and receiving a device description file for the RG and a service description file during a description procedure.

25. The home network system control method according to claim 23, wherein a stack of the protocol uses a Simple Object Access Protocol (SOAP), based on TCP/IP.

26. A method of setting a Residential Gateway, (RG) in a home network system, which includes a Home Network Serving Node (HNSN) for providing home network service, a plurality of devices used in a home, and the RG functioning as a gateway, the method setting the RG based on the Internet for wireless Internet connection between the HNSN and the RG, comprising the steps of:
selecting a command for setting a port table of the RG through a user application;
transmitting an action request message (ACTION-Req) to the HNSN in response to the port table setting command;
transmitting the action request message from the HNSN to the RG;
the RG executing the port table setting command depending on each action; and
transmitting an action response message ACTION-Res) from the RG to the HNSN.

27. The residential gateway setting method according to claim 26, wherein the HNSN and the RG perform discovery and description procedures, which are defined in UPnP, therebetween.

28. The residential gateway setting method according to claim 27, wherein the discovery procedure by the HNSN is performed to discover the RG as a UPnP Device.

29. The residential gateway setting method according to claim 27, wherein the description procedure by the HNSN is performed to receive a device description file for the RG and a service description file for setting a port table.

30. The residential gateway setting method according to claim 26, wherein the action request message includes AddPortMapping, DeletePortMapping, Up-datePortMapping, GetTableAllEntries, GetGenericEntry, GetSpecificEntry, etc.

31. The residential gateway setting method according to claim 26, wherein the port table setting command is implemented perform port forwarding for addition, deletion, change and search.

32. The residential gateway setting method according to claim 26, wherein a protocol stack required for the port table setting uses SOAP (HTTP), based on TCP/IP.

33. A method of setting a residential gateway using a home network system, which includes a central server (HNSN) connected to a mobile network and adapted to control devices and transmit control status thereof, and a Residential Gateway (RG) connected to the central server (HNSN) through a network and connected to a plurality of devices, comprising the steps of:
the gateway transmitting a registration request message, including an ID, password and IP, to the central server;
storing the registration request message received through an interface of the central server in a database;
the central server transmitting a registration response message, including IP and port thereof, to the gateway;
the gateway transmitting an authentication request message, including an ID, password and IP, to the central server at preset intervals if registration has been completed; and
storing the authentication request message received through an interface of the central server, in a database, and updating the database.

34. The residential gateway setting method according to claim 33, wherein if the gateway does not transmit an authentication request message, error processing or failure processing is executed.

35. The residential gateway setting method according to claim 33, wherein if the gateway is deleted, a service stop request message and a service stop response message are transmitted and received, information about a corresponding user is stored in a database, and the database is updated.

36. The residential gateway setting method according to claim 33, wherein a protocol stack between the central server and the gateway uses SOAP (HTTP), based on TCP/IP.

37. A method of processing an event protocol for home network devices in a home network system, which includes a central server (HNSN) connected to a mobile network and adapted to control devices and transmit control status thereof, and a Residential Gateway (RG) connected to the HNSN through a network and connected to a plurality of devices, comprising:
a first step of the central server receiving an event reception request message transmitted by a user;
a second step of transmitting the received event reception request message to the gateway, and the gateway transmitting the event reception request message to a corresponding device;
a third step of transmitting an event reception response message from the device to the gateway, and the gateway transmitting the event reception response message to the central server;
a fourth step of transmitting an event occurrence message generated by the device to the central server through the gateway; and
a fifth step of the central server transmitting an event occurrence response message to the corresponding device via the gateway.

38. The event protocol processing method according to claim 37, further comprising, before the first step, the steps of: the central server discovering a device connected to the gateway using UPnP protocol; and the central server receiving a device description file for the device and a service description file.

39. The event protocol processing method according to claim 37, wherein, after the fourth step, the generated event is stored in a database, and the central server transmits an event message to the user terminal using the mobile network.

40. The event protocol processing method according to claim 37, further comprising, if the user desires to reject reception of an event after the fifth step, the steps of:
the central server receiving an event reception rejection request message transmitted by the user;
transmitting the received event reception rejection request message to the gateway, and the gateway transmitting an event reception rejection request message to a corresponding device; and
transmitting an event reception rejection response message from the device to the gateway, and the gateway transmitting the event reception rejection response message to the central server.

41. The event protocol processing method according to claim 37, wherein a protocol stack between the central server, the gateway and the device uses GENA (HTTP), based on TCP/IP.

42. A method of processing an event protocol in a home network system, which includes a Home Network Serving Node (HNSN), a Residential Gateway (RG), one or more home network devices, a Short Message Service (SMS) center, a Mobile Switching Center (MSC), and a mobile terminal comprising the steps of:
inputting a terminal number of a person, to which an SMS message is to be transmitted, and content through one of the home network devices;
transmitting the input number and content to the HNSN through the RG;
the HNSN transmitting the input number and content to the SMS center; and
the SMS center transmitting an SMS message to a destination mobile terminal via the MSC placed at a location, at which the destination mobile terminal exists, after authenticating the user.

43. The event protocol processing method according to claim 42, wherein the home network devices include a door switch system, a security system, an AV system for home theater, a TV, a Video Cassette Recorder (VCR), a Direct Broadcast Satellite Services (DBSS) system known as a Digital Satellite Services (DSS) system, a sprinkler system, a lighting system, a microwave oven, a dishwasher, an oven/stove, a washing machine/dryer, and electronic device, such as a processing system in a car.

44. A method of processing an event protocol in a home network system, which includes a Home Network Serving Node (HNSN), a Residential Gateway (RG), one or more home network devices, a Short Message Service (SMS) center, a Mobile Switching Center (MSC) and a mobile terminal, comprising the steps of:
requesting transmission of a prestored phone number and content through an SMS message if a preset event occurs in one of the home network devices;
transmitting the phone number and content to the HNSN via the RG;
the HNSN transmitting the received phone number and content to the SMS center; and
the SMS center transmitting an SMS message to a destination mobile terminal via the MSC placed at a location at which the destination mobile terminal exists, after authenticating the user.

45. The event protocol processing method according to claim 44, wherein the preset event includes cases in which a gas leak occurs, a door is not locked during a user's absence, a light is turned on or off by a timer, and a door is opened without permission.

46. The event protocol processing method according to claim 44, wherein the prestored phone number includes phone numbers of a nearby fire station and police station as well as phone numbers of a house owner and family thereof.

47. A method of processing an event protocol in a home network system, which includes a Home Network Serving Node (HNSN), a Residential Gateway (RG), one or more home network devices and a Location Based Service (LBS) server, comprising the steps of:
inputting a phone number of a person, location information of whom is desired to be known, through one of the home network devices;
transmitting the input phone number to the HNSN via the RG; the HNSN determining whether the input phone number is a number available for location inquiry, providing inquiry denial notification to the home network device through the RG and displaying the inquiry denial notification on a Web screen of the device if it is determined that location inquiry is not possible, while requesting location information from the LBS server if it is determined that location inquiry is possible;
the LBS server detecting location information about a corresponding terminal and transmitting detected location information to the HNSN; and
the HNSN displaying the location information on a Web screen of a corresponding device via the RG.

48. The event protocol processing method according to claim 47, wherein the home network devices include a door switch system a security system, an AV system for home theater, a TV, a Video Cassette Recorder (VCR), a Direct Broadcast Satellite Services (DBSS) system known as a Digital Satellite Services (DSS) system, a sprinkler system, a lighting system, a microwave oven, a dishwasher, an oven/stove, a washing machine/dryer, and electronic device, such as a processing system in a car.
